(19) United States
(12) Patent Application Publication
(10) Pub. No.: US 2015/0241711 A1
(43) Pub. Date: Aug. 27, 2015

(54) 3D DISPLAY APPARATUS

(71) Applicant: SHENZHEN CHINA STAR OPTOELECTRONICS TECHNOLOGY CO., LTD., Shenzhen, Guangdong (CN)

(72) Inventor: Chih-Wen Chen, Shenzhen (CN)

(73) Assignee: SHENZHEN CHINA STAR OPTOELECTRONICS TECHNOLOGY CO., LTD., Shenzhen (CN)

(21) Appl. No.: 13/703,379

(22) PCT Filed: Nov. 26, 2012
(86) PCT No.: PCT/CN2012/085244

§ 371 Date: Dec. 11, 2012

(30) Foreign Application Priority Data
Nov. 14, 2012 (CN) 201210456808.1

(51) Int. Cl. G02B 27/22; G02F 1/1335; G02F 1/1343

(52) U.S. Cl. CPC G02B 27/2214; G02F 1/134309; G02F 1/133526

(57) ABSTRACT

The present invention provides a three-dimensional (3D) display apparatus. The 3D display apparatus comprises a display panel and a liquid crystal lens device. The liquid crystal lens device comprises two lens substrate, a liquid crystal lens layer, first elongated electrodes and second elongated electrodes. The elongated electrodes are disposed on inner surfaces of the lens substrates, and there is a predetermined angle between the first elongated electrodes and the second elongated electrodes. The present invention can achieve a stereoscopic image effect and a brightness enhancement.

### FIELD OF THE INVENTION

The present invention relates to a display apparatus, and more particularly to a three-dimensional (3D) display apparatus for displaying 3D images.

### BACKGROUND OF THE INVENTION

Recently, with technological advantages, many types of display apparatus have been widely applied in flat panel displays (FPDs), such as liquid crystal displays (LCDs), electro luminescence (EL) displays or organic light-emitting diode (OLED) displays.

At present, the FPDs are capable of displaying 3D images. Such 3D display devices can be largely divided into a type for which it is necessary to use dedicated glasses and a type for which it is not necessary to use dedicated glasses. Since it is inconvenient for an observer to use dedicated glasses, the type for which it is not necessary to use dedicated glasses (in other words, a type that can form 3D images for the naked eye) is preferable. As 3D display devices that can form 3D images for the naked eye, 3D display devices, for example, employing a parallax barrier system or a lenticular system are known.

However, in the above 3D display device for the naked eye, when two-dimensional (2D) images are displayed, the light rays of the 2D images are required to pass through the parallax barrier system or lenticular system, thereby reducing a brightness of the 2D images.

As a result, it is necessary to provide a 3D display apparatus to solve the problems existing in conventional technologies such as above-mentioned.

### SUMMARY OF THE INVENTION

The present invention provides a 3D display apparatus, so as to solve the problems existing in the conventional 3D display.

A primary object of the present invention is to provide a 3D display apparatus, and the 3D display apparatus comprises: a display panel; and a liquid crystal lens device disposed at a light-emitting side of the display panel, wherein the liquid crystal lens device comprises: a first lens substrate; a second lens substrate; a liquid crystal lens layer formed between the first lens substrate and the second lens substrate; a plurality of first elongated electrodes arranged on an inner surface of the first lens substrate; and a plurality of second elongated electrodes arranged on an inner surface of the second lens substrate, wherein there is a predetermined angle between the first elongated electrodes and the second elongated electrodes.

Another object of the present invention is to provide a 3D display apparatus, and the 3D display apparatus comprises: a display panel; and a liquid crystal lens device disposed at a light-emitting side of the display panel, wherein the liquid crystal lens device comprises: a first lens substrate; a second lens substrate; a liquid crystal lens layer formed between the first lens substrate and the second lens substrate; a plurality of first elongated electrodes arranged on an inner surface of the first lens substrate; and a plurality of second elongated electrodes arranged on an inner surface of the second lens substrate, wherein there is a predetermined angle between the first elongated electrodes and the second elongated electrodes, and the first elongated electrodes are close to a light-emitting side of 3D display apparatus, and the second elongated electrodes are close to the display panel, and wherein, when the two-dimensional (2D) images are displayed, a voltage is applied to the second elongated electrodes, and the first elongated electrodes are connected to ground.

In one embodiment of the present invention, the first elongated electrodes are close to a light-emitting side of 3D display apparatus, and the second elongated electrodes are close to the display panel

In one embodiment of the present invention, the predetermined angle is in the range of 5 degrees to 85 degrees.

In one embodiment of the present invention, the predetermined angle is equal to or less than 30 degrees.

In one embodiment of the present invention, the predetermined angle is in the range of 60 degrees to 90 degrees.

In one embodiment of the present invention, when the 2D images are displayed, a voltage is applied to the second elongated electrodes, and the first elongated electrodes are connected to ground.

In one embodiment of the present invention, the second elongated electrodes are arranged parallel gate lines or data lines of the display panel.

In one embodiment of the present invention, the elongated electrodes are arranged according to a predetermined pitch, and the predetermined pitch is equal to or less than 300 μm.

In one embodiment of the present invention, a space between each adjacent two of the second elongated electrodes is equal to or less than 200 μm.

In comparison with the problems existing in the conventional 3D display, The liquid crystal lens effect can be formed by the liquid crystal lens device of the 3D display apparatus of the present invention, so as to achieve the stereoscopic image effect. Moreover, with the use of the second elongated electrodes, the display brightness of the 3D display apparatus of the present invention can be enhanced for brightness enhancement.

The structure and the technical means adopted by the present invention to achieve the above-mentioned and other objects can be best understood by referring to the following detailed description of the preferred embodiments and the accompanying drawings.

### DESCRIPTION OF THE DRAWINGS

FIG. 1 is a schematic diagram showing a 3D display apparatus according to one embodiment of the present invention;

FIG. 2 and FIG. 3 are schematic diagrams showing elongated electrodes according to one embodiment of the present invention; and

FIG. 4 is a schematic diagram showing the liquid crystal lens device according to one embodiment of the present invention.

### DETAILED DESCRIPTION OF THE PREFERRED EMBODIMENTS

The following embodiments are referring to the accompanying drawings for exemplifying specific implementable embodiments of the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

The drawings and description are to be regarded as illustrative in nature and not restrictive. Like reference numerals designate like elements throughout the specification. In addition, the size and thickness of each component shown in the drawings are arbitrarily shown for understanding and ease of description, but the present invention is not limited thereto.

In the drawings, the thickness of layers, films, panels, regions, etc., are exaggerated for clarity. In the drawings, for understanding and ease of description, the thicknesses of some layers and areas are exaggerated. It will be understood that, when an element such as a layer, film, region, or substrate is referred to as being “on” another element, it can be directly on the other element or intervening elements may also be present.

In addition, in the specification, unless explicitly described to the contrary, the word “comprise” and variations such as “comprises” or “comprising” will be understood to imply the inclusion of stated elements but not the exclusion of any other elements. Furthermore, in the specification, “on” implies being positioned above or below a target element and does not imply being necessarily positioned on the top on the basis of a gravity direction.

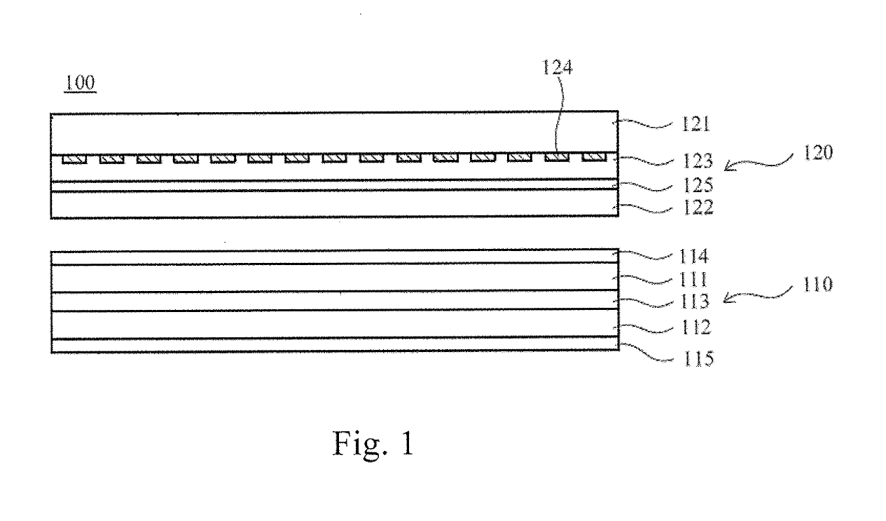

Referring to FIG. 1, a schematic diagram showing a 3D display apparatus according to one embodiment of the present invention is illustrated. The 3D display apparatus 100 of the present embodiment can display 3D images, and the 3D display apparatus 100 comprises a display panel 110 and a liquid crystal lens device 120, and the liquid crystal lens device 120 is disposed at a light-emitting side of the display panel 110. The display panel 110 may be an LCD panel, an OLED panel, a plasma display panel (PDP) or field emission display panel for displaying 2D images. The liquid crystal lens device 120 is disposed at the light-emitting side of the display panel 110 for optically dividing the 2D images into left-eye images and right-eye images, such that the left-eye and right-eye images can be viewed by user's left and right eyes, respectively, for achieving a 3D or stereoscopic image effect.

Referring to FIG. 1 again, in this embodiment, the display panel 110 may be an LCD panel, and at this time, a backlight module can provide a backlight for the display panel 110. In this case, the display panel 110 can comprise a first substrate 111, a second substrate 112, a liquid crystal layer 113, a first polarizer 114 and a second polarizer 115. The first substrate 111 and the second substrate 112 may be realized as glass substrates or flexible plastic substrates. In this embodiment, the first substrate 111 may be a glass substrate or other material substrates with color filters (CF), and the second substrate 112 may be a glass substrate or other material substrates with a thin film transistor (TFT) array. It should be noted that the color filters and the TFT array may also be disposed on the same substrate in other embodiments. The liquid crystal layer 113 is formed between the first substrate 111 and the second substrate 112. The first polarizer 114 is disposed on an outer side of the first substrate 111 and opposite to the liquid crystal layer 113. The second polarizer 115 is disposed on an outer side of the second substrate 112. The liquid crystal lens device 120 is disposed at the light-emitting side of the display panel 110, and more specifically, the liquid crystal lens device 120 is disposed on an outer surface of the first polarizer 114.

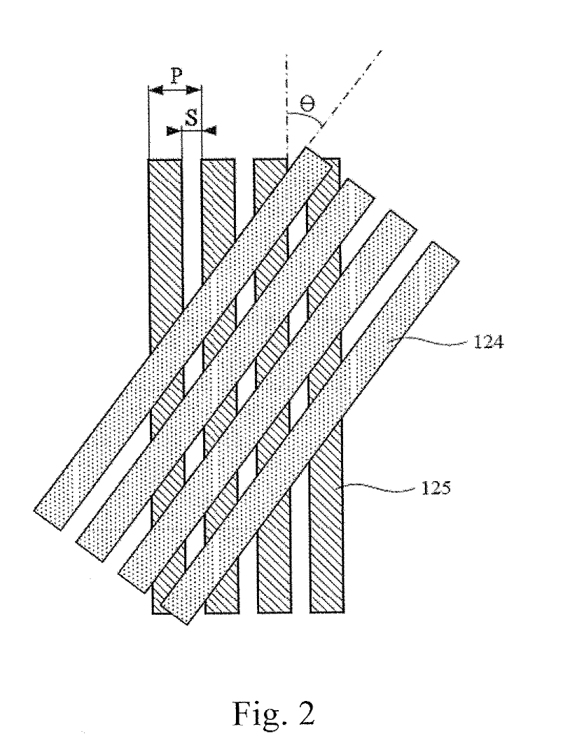

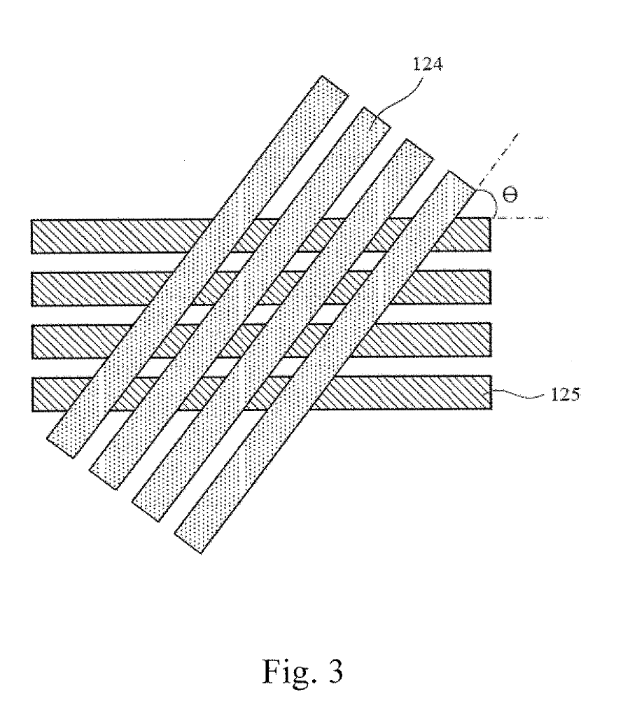

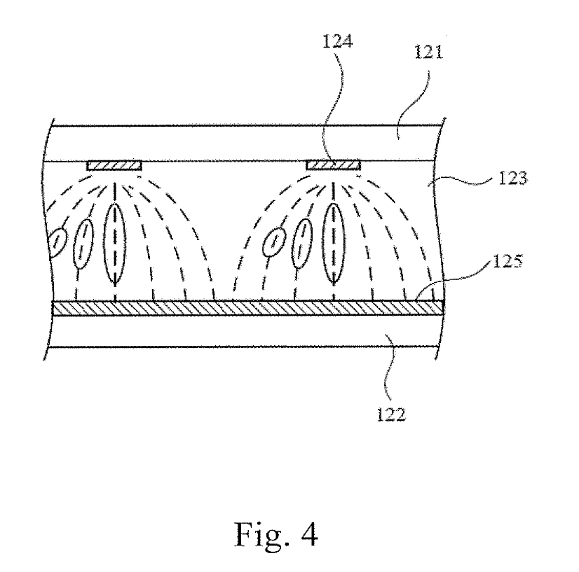

Referring to FIG. 1 through FIG. 4, FIG. 2 and FIG. 3 are schematic diagrams showing elongated electrodes according to one embodiment of the present invention, and FIG. 4 is a schematic diagram showing the liquid crystal lens device according to one embodiment of the present invention is illustrated. The liquid crystal lens device 120 can comprise a first lens substrate 121, a second lens substrate 122, a liquid crystal lens layer 123, a plurality of first elongated electrodes 124 and a plurality of second elongated electrodes 125. The liquid crystal lens layer 123 is formed between the first lens substrate 121 and the second lens substrate 122 for forming a optical lens effect. The first elongated electrodes 124 are arranged on an inner surface of the first lens substrate 121. That is, the first elongated electrodes 124 face the liquid crystal lens layer 123. The second elongated electrodes 125 are arranged on an inner surface of the second lens substrate 122. That is, the second elongated electrodes 125 face the liquid crystal lens layer 123.

Referring to FIG. 4 again, the first lens substrate 121 and the second lens substrate 122 may be transparent substrates, such as glass substrates or flexible plastic substrates. In this embodiment, the first lens substrate 121 (or the first elongated electrodes 124) can be close to the light-emitting side of the 3D display apparatus 100, and the second lens substrate 122 (or the second elongated electrodes 125) can be close to the display panel 110.

Referring to FIG. 4 again, the liquid crystal lens layer 123 can include liquid crystal molecules, and by changing the arrangement direction of the liquid crystal molecules in accordance with a voltage applied by the first elongated electrodes 124 and the second elongated electrodes 125, a lens effect is controlled. The liquid crystal molecules of the liquid crystal lens layer 123 can have dielectric anisotropy and refractive index anisotropy and, for example, have an index ellipsoid that has different refractive indices for a light beam transmitted in the longitudinal direction and a light beam transmitted in the short side direction.

Referring to FIG. 2 and FIG. 3 again, the first elongated electrodes 124 and the second elongated electrodes 125 are elongated and made of a transparent conductive material, such as ITO, IZO, AZO, ATO, GZO, TCO, ZnO or PEDOT. In this case, the second elongated electrodes 125 are arranged parallel to signal lines (such as gate lines or data lines) of the display panel 110, i.e. parallel to an arrangement direction of pixels of the display panel 110. Moreover, there is a predetermined angle θ between the first elongated electrodes 124 and the second elongated electrodes 125, and the predetermined angle θ may be less than 90 degrees, such as 5˜85 degrees.

Referring to FIG. 2 and FIG. 3 again, the second elongated electrodes 125 can be arranged according to a predetermined pitch P, and the predetermined pitch P is preferably equal to or less than 300 μm, and a space S between each adjacent two of the second elongated electrodes 125 is preferably equal to or less than 200 μm, such as equal to or less than 100 or 80 μm, for enhancing a design of the second elongated electrodes 125.

In addition, a first alignment film (not shown) can be formed on the first elongated electrodes 124 and contact the liquid crystal lens layer 123, and a second alignment film (not shown) can be formed on the second elongated electrodes 125 and contact the liquid crystal lens layer 123.

In a 3D display mode, when the 3D images are displayed, voltages can be applied to the first elongated electrodes 124 and the second elongated electrodes 125, so as to form an electric field with a gradient variation. The liquid crystal molecules of the liquid crystal lens layer 123 can be driven by the electric field for varying the longitudinal direction thereof, and thus the liquid crystal lens layer 123 can have a liquid crystal lens effect. Accordingly, the light rays emitted from different pixels of the display panel 110 can be refracted in different directions by the liquid crystal lens of the liquid crystal lens layer 123, respectively. In other words, the light rays emitted from the left and right eye pixels of the display panel 110 can be refracted to the user's left and right eyes by the liquid crystal lens of the liquid crystal lens layer 123, respectively. Thus, left and right eye images can be viewed by the user's left and right eyes, respectively, thereby forming a stereoscopic image effect.

In a 2D display mode, when the 2D images are displayed, a voltage can be applied to the second elongated electrodes 125, and the first elongated electrodes 124 are connected to ground. Thus, an electric field parallel to the second elongated electrodes 125 can be formed, and the liquid crystal molecules are twisted to being parallel to the signal lines (the gate lines or the data lines) of the display panel 110 for allowing linearly polarized light rays to entirely pass through the liquid crystal molecules of the liquid crystal lens layer 123. In this manner, a display brightness of the 3D display apparatus 100 can be enhanced for brightness enhancement.

In one embodiment, the second elongated electrodes 125 may be parallel to the data lines of the display panel 110, and the predetermined angle θ between the first elongated electrodes 124 and the second elongated electrodes 125 can be equal to or less than 30 degrees, so as to enhance the liquid crystal lens effect of the liquid crystal lens device 120. In this case, the predetermined angle θ may be 9 or 17 degrees for enhancing the liquid crystal lens effect of the liquid crystal lens device 120.

In one embodiment, the second elongated electrodes 125 may be parallel to the gate lines of the display panel 110, and the predetermined angle θ between the first elongated electrodes 124 and the second elongated electrodes 125 can be 60˜90 degrees, so as to enhance the liquid crystal lens effect of the liquid crystal lens device 120. In this case, the predetermined angle θ may be 73 or 81 degrees for enhancing the liquid crystal lens effect of the liquid crystal lens device 120.

As described above, in the 3D display apparatus of the present invention, the liquid crystal lens effect can be formed by the liquid crystal lens device to achieve the stereoscopic image effect. Moreover, with the use of the second elongated electrodes, the display brightness of the 3D display apparatus can be enhanced for brightness enhancement.

The present invention has been described above with a preferred embodiment thereof, and it is understood that many changes and modifications to the described embodiment can be carried out without departing from the scope and the spirit of the invention that is intended to be limited only by the appended claims.

1. A three-dimensional (3D) display apparatus, comprising:
a display panel; and
a liquid crystal lens device disposed at a light-emitting side of the display panel, wherein the liquid crystal lens device comprises:
a first lens substrate;
a second lens substrate;
a liquid crystal lens layer formed between the first lens substrate and the second lens substrate;
a plurality of first elongated electrodes arranged on an inner surface of the first lens substrate; and
a plurality of second elongated electrodes arranged on an inner surface of the second lens substrate, wherein there is a predetermined angle between the first elongated electrodes and the second elongated electrodes;
wherein the first elongated electrodes are close to a light-emitting side of 3D display apparatus, and the second elongated electrodes are close to the display panel;
wherein, when the two-dimensional (2D) images are displayed, a voltage is applied to the second elongated electrodes, and the first elongated electrodes are connected to ground.

2. The 3D display apparatus according to claim 1, wherein the predetermined angle is in the range of 5 degrees to 85 degrees.

3. The 3D display apparatus according to claim 1, wherein the predetermined angle is equal to or less than 30 degrees.

4. The 3D display apparatus according to claim 1, wherein the predetermined angle is in the range of 60 degrees to 90 degrees.

5. The 3D display apparatus according to claim 1, wherein the second elongated electrodes are arranged parallel gate lines or data lines of the display panel.

6. The 3D display apparatus according to claim 1, wherein the elongated electrodes are arranged according to a predetermined pitch, and the predetermined pitch is equal to or less than 300 μm.

7. The 3D display apparatus according to claim 1, wherein a space between each adjacent two of the second elongated electrodes is equal to or less than 200 μm.

8. A 3D display apparatus, comprising:
a display panel; and
a liquid crystal lens device disposed at a light-emitting side of the display panel, wherein the liquid crystal lens device comprises:
a first lens substrate;
a second lens substrate;
a liquid crystal lens layer formed between the first lens substrate and the second lens substrate;
a plurality of first elongated electrodes arranged on an inner surface of the first lens substrate; and
a plurality of second elongated electrodes arranged on an inner surface of the second lens substrate, wherein there is a predetermined angle between the first elongated electrodes and the second elongated electrodes.

9. The 3D display apparatus according to claim 8, wherein the first elongated electrodes are close to a light-emitting side of 3D display apparatus, and the second elongated electrodes are close to the display panel

10. The 3D display apparatus according to claim 8, wherein the predetermined angle is in the range of 5 degrees to 85 degrees.

11. The 3D display apparatus according to claim 10, wherein the predetermined angle is equal to or less than 30 degrees.

12. The 3D display apparatus according to claim 8, wherein the predetermined angle is in the range of 60 degrees to 90 degrees.

13. The 3D display apparatus according to claim 8, wherein, when the 2D images are displayed, a voltage is applied to the second elongated electrodes, and the first elongated electrodes are connected to ground.

14. The 3D display apparatus according to claim 8, wherein the second elongated electrodes are arranged parallel gate lines or data lines of the display panel.

15. The 3D display apparatus according to claim 8, wherein the elongated electrodes are arranged according to a predetermined pitch, and the predetermined pitch is equal to or less than 300 μm.

16. The 3D display apparatus according to claim 8, wherein a space between each adjacent two of the second elongated electrodes is equal to or less than 200 μm.
